(19) United States
(12) Patent Application Publication
(10) Pub. No.: US 2004/0151631 A1
(43) Pub. Date: Aug. 5, 2004

(54) Determination of analytes by means of fluorescence correlation spectroscopy

(76) Inventor: Rudolf Rigler, St-Sulpice (CH)

Correspondence Address: ROTHWELL, FIGG, ERNST & MANBECK, P.C., 1425 K STREET, N.W., SUITE 800, WASHINGTON, DC, 20005, US

(21) Appl. No.: 10/471,235

(22) PCT Filed: Mar. 8, 2002
(86) PCT No.: PCT/EP02/02582

(30) Foreign Application Priority Data
Mar. 9, 2001 (DE) 101 11 420.6

(51) Int. Cl. G01N 21/64

(52) U.S. Cl. 422/82.08; 436/172

(57) ABSTRACT

The invention relates to a method for the determination of an analyte in a sample by fluorescence correlation spectroscopy, the distance between the measurement volume in the sample and the optical excitation/detection direction being ≧1 mm and the sample liquid being thermally insulated from the optical instrument. The method is especially suitable for the measurement of temperature-dependent processes, for example the determination of nucleic acid hybridization melting curves and/or for carrying out nucleic acid amplification reactions. A device suitable for carrying out the method according to the invention is furthermore disclosed.

The invention relates to a method for the determination of an analyte in a sample by fluorescence correlation spectroscopy, the distance between the measurement volume in the sample and the optical excitation/detection direction being ≧1 mm and the sample liquid being thermally insulated from the optical instrument. The method is especially suitable for the measurement of temperature-variable processes, for example the determination of nucleic acid hybridization melting curves and/or for carrying out nucleic acid amplification reactions. A device suitable for carrying out the method according to the invention is also disclosed.

The use of fluorescence correlation spectroscopy (FCS) for the detection of analytes is known. EP-B-0 679 251 discloses methods and devices for the detection of analytes by means of fluorescence spectroscopy, the determination being carried out in a measurement volume which is part of the sample to be studied, and the measurement volume being arranged at a working distance of ≦1000 μm from an optical focusing device. Furthermore, the focusing instrument is either directly in contact with the sample or separated from the sample merely by an optically transmissive film. It has previously been assumed that the short distance and the direct contact between the sample and the optical device is a necessary feature of fluorescence correlation spectroscopy. This arrangement, however, has the disadvantage that processes involving a temperature change of the sample can only be studied with great difficulty.

DE-A-36 42 798 discloses a microscope with a stand which is displaceably mounted on an object stage, the drive instrument for vertical displacement of the object stage forming an independent support of the object stage, separate from the guide device. The temperature of the microscope can be regulated by the delivery of cooling air and by fitting thermal protection filters. There is no indication of use in fluorescence correlation spectroscopy.

GB-A-2 351 556 describes a method for the measurement of radiation, a plurality of confocal optical single-channel systems and photoelectric detectors being arranged in parallel in order to form a plurality of read heads, which are arranged next to one another so as to be able to evaluate radiation from corresponding regions simultaneously. 10× microscope objectives with a numerical aperture of 0.4, a focal length of about 8 mm and an aperture diameter of 5 mm may be used as the focusing optics. There is absolutely no indication that the focusing optics may be thermally insulated from the sample.

DE-C-42 18 729 discloses capillary electrophoresis apparatus with an optical position-resolving detection system. The temperature inside the capillary can be thermostatted. There is no indication of confocal fluorescence correlation spectroscopy.

DE-A-197 48 211 describes an optical system with a lens array which can be used for fluorescence correlation spectroscopy. In order to produce confocal volume elements in the samples, lenses are used with a focal length of f=7.5 and a numerical aperture of 0.6. There is absolutely no indication of thermal insulation of the focusing optics from the sample.

DE-A-199 19 092 describes an arrangement for the optical evaluation of an object array, which may be used for fluorescence analysis. Here again, there is absolutely no indication of thermal insulation of the focusing optics and the samples.

It is an object of the present application to provide methods and devices for carrying out fluorescence correlation spectroscopy, which at least partially avoid the disadvantages of the prior art.

The invention therefore relates to a method for the determination of an analyte in a sample by fluorescence correlation spectroscopy, comprising the steps of:

(a) preparing a sample liquid in a support,

(b) carrying out a luminescence measurement by optical stimulation of luminescent molecules in a measurement volume, which is part of the sample liquid, by using a light source with focusing optics and a detector for picking up emission radiation from the measurement volume,

characterized in that the distance between the measurement volume in the sample liquid and the focusing instrument of the light source is ≧1 mm and in that the sample liquid is thermally insulated from the light source and, in particular, from the focusing optics.

An essential advantage of the method according to the invention is that the temperature of the support, and therefore of the sample, can be adjusted and varied independently of the optical excitation/detection device, and in particular its focusing optics, for example one or more micro-objectives.

In other regards, the method may basically be carried out according to the method described in EP-B-0 679 251. In this case, the measurement of one or a few analyte molecules is preferably carried out in a measurement volume, the concentration of the analyte molecules to be determined preferably being ≦10⁻¹⁴ mol/l. Substance-specific parameters are determined, which are found by luminescence measurement of the analyte molecules. These parameters may be translation diffusion coefficients, rotation diffusion coefficients and/or the excitation wavelength, the emission wavelength and/or the lifetime of an excited state of a luminescent molecule or the combination of one or more of these measurement quantities. For specifics about equipment details, reference is made to the disclosure of EP 0 679 251.

An essential feature of the method according to the invention is that the distance between the measurement volume in the sample liquid and the focusing optics of the light source is ≧1 mm, preferably from 1.5 to 10 mm and particularly preferably from 2 to 5 mm. It is furthermore preferable for a gas phase region, which may contain air, protective gas or vacuum, to be arranged between the support containing the sample liquid and the optical focusing instrument.

The support used for carrying out the method according to the invention is preferably a microstructure which contains a plurality of preferably separate containers for holding samples. The volume of these containers is preferably in the range of ≦10⁻⁶¹, and particularly preferably ≦10⁻⁸. For instance, the support may comprise a microwell structure with a plurality of wells for holding sample liquid, which for example have a diameter of between 10 and 1000 μm. Suitable microstructures are described, for example, in DE 100 23 421.6 and DE 100 65 632.3. The support furthermore preferably comprises at least one temperature control element, for example a Peltier element, which allows temperature regulation of the support and/or individual sample containers in it.

The support used for the method is furthermore expediently configured in such a way that it allows optical detection of the sample. A support which is optically transparent at least in the vicinity of the sample containers is therefore preferably used. The support may in this case either be fully optically transparent or contain an optically transparent base and an optically opaque cover layer with openings in the sample containers. Suitable materials for supports are, for example, composite supports made of metal (for example silicon for the cover layer) and glass (for the base). Such supports may, for example, be produced by applying a metal layer with predetermined openings for the sample containers onto the glass. Plastic supports, for example made of polystyrene or polymers based on acrylate or methacrylate may alternatively be used. It is furthermore preferable for the support to have a cover for the sample containers, in order to provide a system which is closed and essentially isolated from the surroundings during the measurement.

In a particularly preferred embodiment, a support is used which contains a lens element arranged in the beam path between the measurement volume and the light source or the detector of the optical device. For example, the lens element may be fitted at the bottom of a microwell structure. Such a lens element may, for example, be produced by heating and shaping a photoresist by using a master mold, for example made of metal such as silicon, and then applied onto the support. Alternatively—for example when supports made of a fully plastic structure are being used—the lens elements may be integrated into the support, for example produced during production by injection molding. The numerical aperture of the optical measuring arrangement may be increased by using a lens element, preferably a convex lens element. This numerical aperture is preferably in the range of from 0.5 to 1.2.

The support is furthermore preferably coated with a transparent antireflection coat, in order to obtain a higher refractive index. Transparent oxides or nitrides may, for example, be used as antireflection coats. Antireflection coatings are preferably also used on the optics.

Electric fields may furthermore be produced in the support, especially in the vicinity of the sample containers, in order to achieve concentration of the analytes to be determined in the measurement volume. Examples of electrodes which are suitable for producing such electric fields are described, for example in DE 101 03 304.4.

Owing to the thermal decoupling of the support and the optics, the method according to the invention makes it possible to carry out a determination at a different temperature from the surroundings, and in particular allows variation of the temperature during the measurement. The spatial decoupling of the support and the optics allows simplified scanning of supports, in particular microwell structures with a plurality of separate sample containers.

The method according to the invention is in principle suitable for the detection of any analytes. One or more substances which bind analytes, and which carry marking groups that can be detected by luminescence measurement, especially fluorescent marking groups, are preferably added to the sample. In this case, the method according to the invention preferably comprises determination of the binding of the marking substance to the analyte to be detected. This detection may, for example, be carried out by using a mobility change of the marking group due to the binding to the analyte or using a change in the luminescence of the marking group (intensity and/or decay time) due to the binding to the analyte, or by the so-called cross-correlation if a plurality of marking groups are being used. In the cross-correlation determination, at least two different markings are used, especially fluorescent markings, whose correlated signal inside the measurement volume is determined. This cross-correlation determination is described, for example, in Schwille et al. (Biophys. J. 72 (1997), 1878-1886) and Rigler et al. (J. Biotechnol. 63 (1998), 97-109).

The method according to the invention is especially suitable for the detection of biomolecules, for example nucleic acids, proteins or other analyte molecules which occur in living bodies, especially in mammals such as humans. It is furthermore possible to detect analytes which have been produced from biological samples in vitro, for example cDNA molecules which have been produced from mRNA by reverse transcription, or proteins which have been produced from mRNA or DNA by in vitro translation. The method is furthermore suitable for the detection of analytes which exist as elements of a library and are intended to show predetermined characteristics, for example binding to the detection reagent. Examples of such libraries are phage libraries or ribosomal libraries.

In a particularly preferred embodiment, the determination comprises a nucleic acid hybridization, with one or more luminescence-marked probes binding to a target nucleic acid as the analyte. Such hybridization methods may, for example, be used for the analysis of gene expression, for example in order to determine a gene expression profile, or for the analysis of mutations, for example single-nucleotide polymorphisms (SNPs). The method according to the invention is, however, also suitable for the determination of enzymatic reactions and/or for the determination of nucleic acid amplifications, especially in one or more thermocycling processes. Preferred methods for the determination of nucleic acid polymorphisms are described in DE 100 56 226.4 und DE 100 65 631.5. A two-color or multi-color cross-correlation determination is particularly preferably carried out in this case.

In a further particular preferred embodiment, the determination comprises the detection of a protein-protein or protein-ligand interaction, in which case low molecular-weight active agents, peptides, nucleic acids etc. may be used as protein ligands. A two-color or multi-color correlation method is also preferably carried out for such determinations.

In an alternative preferred embodiment, so-called “molecular beacon” probes or primers may be used, which —when they are in the free form—give rise to a different measurement signal in respect of the luminescence intensity and/or decay time than in the bound state.

In yet another alternative preferred embodiment, the determination may comprise the measurement of an energy transfer, which is caused by at least one luminescence marker as the energy donor and at least one luminescence marker as the acceptor. The donor and acceptor are present in a complex containing the analyte and one or more detection reagents, preferably at least 2 detection reagent.

The invention also relates to a device for the determination of an analyte by means of fluorescence correlation spectroscopy (FCS), in particular for carrying out the method, comprising

(a) a support with at least one container for holding a sample liquid, which contains the analyte to be determined,

(b) an optical excitation instrument comprising a light source and focusing optics for the stimulation of luminescence in a measurement volume, which is part of the sample liquid, and

(c) an optical detection instrument for the detection of luminescence from the measurement volume, characterized in that the distance between the focusing optics and the measurement volume is ≧1 mm, and in that the support is thermally insulated from the excitation instrument.

The support is preferably a microstructure with a plurality of, preferably at least 10², containers for holding a sample liquid, in which case the sample liquid in the separate containers may come from one or more sources. The sample liquid may, for example, be introduced into the containers of the support by means of a piezoelectric liquid delivery device.

The containers of the support are configured in such a way that they allow binding of the detection reagent to the analyte in solution. The containers are preferably wells in the support surface, in which case these wells may in principle have any shape, for example circular, square, rhombic etc. The support may even comprise 10³ or more separate containers.

The optical excitation instrument comprises a strongly focused light source, preferably a laser beam, which is focused onto the measurement volume in the sample liquid by means of appropriate optical instruments. The light source may also contain two or more laser beams, which are then respectively focused onto the measurement volume by different optics before entering the sample liquid. The detection instrument may, for example, contain a fiber-coupled avalanche photodiode detector or an electronic detector. It is, however, also possible to use excitation and/or detection matrices consisting of a point matrix of laser points, produced by diffraction optics or a quantum-well laser, as well as a detector matrix produced by an avalanche photodiode matrix, or an electronic detector matrix, for example a CCD camera.

The support may be provided in prefabricated form, a plurality of separate containers of the support being filled with luminescence-marked detection reagents, preferably luminescence-marked hybridization probes or primers. The support containing the detection reagents is then advantageously dried.

In a preferred embodiment of the invention, a prefabricated support is provided which contains a multiplicity of, for example 100, separate containers which are respectively filled with different detection reagents, for example reagents such as primers and/or probes for the detection of a nucleic acid hybridization. This support may then be filled with a sample coming from a body to be studied, for example a human patient, so that different analytes from a single sample are determined in the respective containers. Such supports may, for example, be used to compile a gene expression profile, for example for the diagnosis of diseases, or for the determination of nucleic acid polymorphisms, for example for the detection of a particular genetic predisposition.

The invention furthermore relates to a method for the determination of nucleic acid polymorphisms. This method is preferably used in combination with the aforementioned fluorescence correlation spectroscopy method, although it may also be used for other types of single-molecule detection or for conventional detection methods.

This method comprises the steps of:

(a) preparing a nucleic acid matrix to be studied and two probes that bind to the matrix under hybridization conditions, the probes being selected in such a way that

(i) they bind directly to the matrix next one another, so that the 3′ end of the first probe is directly next to the 5′ end of the second probe,

(ii) positions at which the occurrence of a polymorphism is to be expected on the matrix are selected for the 3′ end of the first probe and/or the 5′ end of the second probe,

(iii) the nucleotides at the 3′ end of the first probe and/or at the 5′ end of the second probe are complementary to the respective positions on the matrix when it has a first predetermined variant of the polymorphism, and not complementary to the respective positions on the matrix when it has another variant of the polymorphism,

(b) hybridization of the probes onto the matrix,

(c) treatment of the hybridization complex comprising the matrix and the first and second probes bound to it, with a ligase under conditions such that ligation of the first and second probes takes place selectively only if the nucleotide at the 3′ end of the first probe and the nucleotide at the 5′ end of the second probe are complementary to the respective positions of the matrix, and

(d) detection of whether a ligation has taken place between the first and second probes, in order to determine the variant of the polymorphism present on the matrix.

In the simplest case, the nucleic acid polymorphism is a single-nucleotide polymorphism (SNP). The polymorphism may, however, also affect two or more nucleotides.

DNA of any origin, for example from natural sources but also recombinantly produced DNA or synthetic DNA, may be used as nucleic acid matrices. The DNA preferably comes from a body in which nucleic acid polymorphisms occur, which are intended to be determined by the method. The DNA is preferably used in single-stranded form, for example as single-stranded cDNA. It is, however, also possible to use double-stranded DNA, which is separated into single-stranded DNA by heating and is then used for the hybridization with the probes.

The hybridization probes preferably consist at least partially of single-stranded DNA. In any event, the 3′ end of the first probe must be ligatable to the 5′ end of the second probe, preferably with the use of a DNA ligase. The probes may, however, also be formed by nucleic acid analogs, for example peptide nucleic acids. Preferably, the first probe contains a free 3′ OH group at the 3′ end and the second probe contains a 5′ phosphate group at the 5′ end.

Preferably, the first and second probes each carry a different marking group, the joint occurrence of which can be detected by a cross-correlation determination. This means that the presence of the two different marking groups in a single molecule (ligation product) can be detected separately from presence in two separate molecules (first and second probe). The size differences between the ligation product and the individual probes results in very different hybridization melting points, and therefore in a high sensitivity of the method. If, for example, a melting point curve measurement of the hybrids is carried out, the cross-correlation for the single probes vanishes immediately above the lowest melting point of an individual probe, while the ligation product still gives a cross-correlated signal up to substantially higher temperatures (up to its melting point, which is preferably ≧10° C. higher).

Fluorescence markings are preferably used as the marking groups, for instance, fluorescein, rhodamine, phycoerythrin, CY3, CY5 or derivatives thereof. The discrimination of the fluorescence marking groups may be carried out using the emission wavelength, using the lifetime of the excited states or using a combination thereof.

As mentioned above, the detection may preferably be carried out by means of single-molecule determination, for example with position and/or time-resolved fluorescence spectroscopy which is capable of detecting fluorescence signals in a very small volume element like in a microchannel or a microwell down to single-photon counts.

For example, the detection may be carried out by means of confocal single-molecule detection, for instance by fluorescence correlation spectroscopy. Alternatively, the detection may also be carried out by a time-resolved decay measurement, so-called time gating, in which case the fluorescence molecules inside a measurement volume are stimulated and a detection interval on the photodetector is then opened preferably in a time interval of ≧100 ps. This measurement method is, for example, described by Rigler et al. in “Ultrafast Phenomena” D. H. Auston, ed. Springer 1984.

The present invention will also be explained by the following figures, in which:

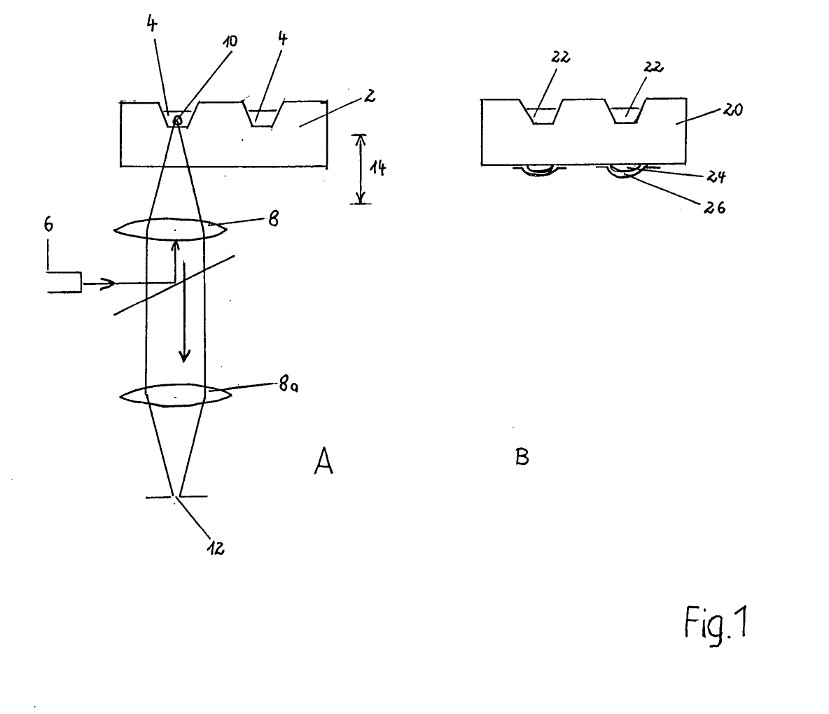

FIG. 1A shows the schematic representation of a support (2) which is suitable for carrying out the method according to the invention, with a multiplicity of containers (4) for holding sample liquid which are designed in the form of wells on the support. A support with an area of 1-2 cm² may, for example, contain up to 10⁴ wells.

For the detection of an analyte in a container (4), an excitation and detection device preferably arranged under the support base may be used. This device may contain a light source (6), for example a laser, with which light can be shone via an optical focusing instrument (8) into a measurement volume (10) inside the sample liquid. The luminescence radiation emitted from the measurement volume is conducted via the optical focusing instrument (8; 8a) to a detector (12). The measurement volume (10) is arranged at a working distance (14) of ≧1 mm, and preferably >1 mm from, the focusing instrument (8). The support (2) is furthermore thermally insulated from the optical excitation and detection device, for example by arranging a gas phase region between the optical focusing instrument (8) and the support (2).

FIG. 1B shows the schematic representation of a particularly preferred embodiment of a support (20) which is suitable for carrying out the method according to the invention. The support (20) also has a multiplicity of separate containers (22) for holding a sample liquid. A preferably convex lens element (24) is additionally arranged in the beam path between the optical excitation and detection device (not shown) and the measurement volume (not shown) contained in the sample liquid. This lens element advantageously has an anti-reflecting coat (26).

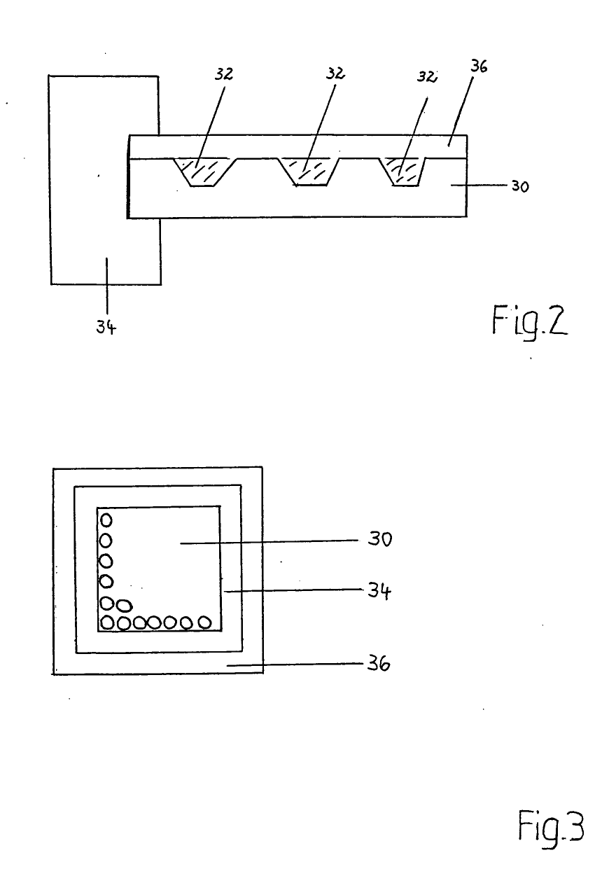

FIG. 2 shows the schematic representation of a particularly preferred embodiment of a support (30) which is suitable for carrying out the method according to the invention, with a multiplicity of separate containers (32) for holding sample liquids. The support furthermore contains a temperature control element (34), for example a Peltier element. The temperature control element is preferably arranged at least partially around the support circumference. In order to allow a temperature-variable determination, the containers (32) are provided with a cover (36) from the surroundings, which essentially insulates the sample liquid from the surroundings. For example, seals (not shown) may be used for this purpose.

FIG. 3 shows a plan view of the support (30) with the temperature control element (34) represented in FIG. 2. This arrangement may optionally be fitted on a frame holder (36) with the use of additional heating or cooling elements (not shown).

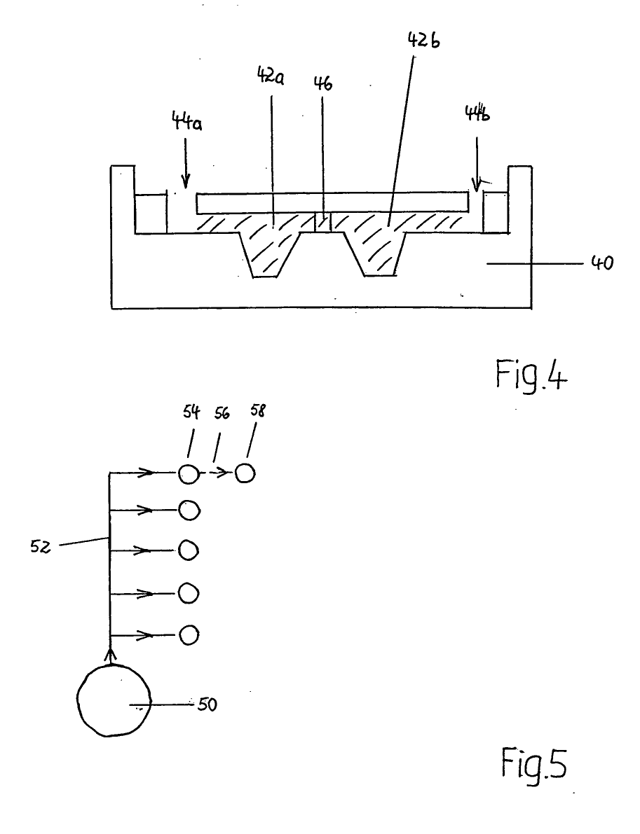

FIG. 4 shows the introduction of the sample into a support (40) with separate containers (42a; 42b) via accesses (44a, 44b). The containers (42a) and (42b) are separated by a barrier (46). The barrier may be designed as a permanent barrier or as a valve, for example a hydrophobic diaphragm valve which can be made permeable by pressure application. The sample liquid may be introduced simultaneously into a plurality of containers, or—after the first container has been filled—via a valve (46) into the second container.

FIG. 5 shows a particularly preferred embodiment of the introduction of sample liquid into the support. The sample liquid is conducted from a reservoir (50), optionally integrated on the support itself, respectively via feed lines (52) in parallel into sample containers (54). The sample liquid may optionally be conducted from the containers (54) via a valve (56) into a further container (58), that is to say the parallel filling may be combined with serial filling.

1. A method for the determination of an analyte in a sample by fluorescence correlation spectroscopy, comprising the steps of:
(a) preparing a sample liquid in a support,
(b) carrying out a luminescence measurement by optical stimulation of luminescent molecules in a measurement volume, which is part of the sample liquid, by using a light source with focusing optics and a detector for picking up emission radiation from the measurement volume,
characterized in that the distance between the measurement volume in the sample liquid and the focusing instrument of the light source is ≧1 mm and in that the sample liquid is thermally insulated from the light source and, in particular, from the focusing optics.

2. The method as claimed in claim 1, characterized in that the distance is from 1 to 10 mm, preferably from 2 to 5 mm.

3. The method as claimed in claim 1 or 2, characterized in that a gas phase region is arranged between the support and the focusing optics.

4. The method as claimed in one of the preceding claims, characterized in that the support contains a lens element, which is arranged in the beam path between the measurement volume and the light source or the detector.

5. The method as claimed in one of the preceding claims, characterized in that the optical measuring arrangement has a numerical aperture from 0.5 to 1.2.

6. The method as claimed in one of the preceding claims, characterized in that the support has a plurality of, preferably at least 10² separate containers for holding samples.

7. The method as claimed in claim 6, characterized in that the support of comprises a microwell structure with a plurality of wells, which preferably have a diameter of between 10 and 1000 μm.

8. The method as claimed in one of the preceding claims, characterized in that the support comprises at least one temperature control element.

9. The method as claimed in claim 8, characterized in that the determination is at least partially carried out at a different temperature than the surroundings.

10. The method as claimed in claim 8 or 9, characterized in that the temperature is varied during the measurement.

11. The method as claimed in one of the preceding claims, characterized in that the determination comprises the binding of at least one luminescence-marked detection reagent to the analyte.

12. The method as claimed in one of the preceding claims, characterized in that the determination comprises a nucleic acid hybridization, with one or more luminescence-marked probes binding to a target nucleic acid.

13. The method as claimed in claim 11 or 12, characterized in that the determination comprises the measurement of a cross-correlated signal, which originates from a complex of an analyte and detection reagent(s), containing at least 2 different luminescence markings.

14. The method as claimed in one of claims 11 to 13, characterized in that the determination comprises the measurement of a signal originating from at least one luminescence-marked detection reagent, the luminescence intensity and/or decay time of the detection reagent being different when bound to the analyte than in the unbound state.

15. The method as claimed in claim 14, characterized in that the differences in the luminescence intensity and/or decay time are caused by quenching or energy transfer processes.

16. The method as claimed in one of claims 11 to 15, characterized in that the determination comprises the measurement of an energy transfer, which originates from at least one luminescence-marker as the donor and from at least one luminescence marker as the acceptor, which are present in a complex of the analyte and one or more detection reagents.

17. The method as claimed in one of the preceding claims, characterized in that the determination comprises an enzymatic reaction.

18. The method as claimed in one of claims 12 to 17, characterized in that the determination comprises a nucleic acid amplification, in particular one or more thermocycling processes.

19. The method as claimed in one of claims 12 to 18, characterized in that the determination comprises a mutation analysis in the case of nucleic acids.

20. The method as claimed in one of claims 12 to 19, characterized in that the determination comprises a gene expression analysis in the case of nucleic acids.

21. The method as claimed in one of claims 12 to 20, characterized in that the determination comprises the measurement of a temperature-dependent melting curve in the case of a nucleic acid hybridization.

22. A device for the determination of an analyte by means of fluorescence correlation spectroscopy (FCS), in particular for carrying out the method as claimed in one of claims 1 to 21, comprising
(a) a support with at least one container for holding a sample liquid, which contains the analyte to be determined,
(b) an optical excitation instrument comprising a light source and focusing optics for the stimulation of luminescence in a measurement volume, which is part of the sample liquid, and
(c) an optical detection instrument for the detection of luminescence from the measurement volume, characterized in that the distance between the focusing optics and the measurement volume is >1 mm, and in that the support is thermally insulated from the excitation instrument.

23. A method for the determination of nucleic acid polymorphisms, comprising the steps of:
(a) preparing a nucleic acid matrix to be studied and two probes that bind to the matrix under hybridization conditions, the probes being selected in such a way that
(i) they, bind directly to the matrix next one another, so that the 3′ end of the first probe is directly next to the 5′ end of the second probe,
(ii) positions at which the occurrence of a polymorphism is to be expected on the matrix are selected for the 3′ end of the first probe and/or the 5′ end of the second probe,
(iii) the nucleotides at the 3′ end of the first probe and/or at the 5′ end of the second probe are complementary to the respective positions on the matrix when it has a first predetermined variant of the polymorphism, and not complementary to the respective positions on the matrix when it has another variant of the polymorphism,
(b) hybridization of the probes onto the matrix,
(c) treatment of the hybridization complex comprising the matrix and the first and second probes bound to it, with a ligase under conditions such that ligation of the first and second probes takes place selectively only if the nucleotide at the 3′ end of the first probe and the nucleotide at the 5′ end of the second probe are complementary to the respective positions of the matrix, and
(d) detection of whether a ligation has taken place between the first and second probes, in order to determine the variant of the polymorphism present on the matrix.
